(19) United States
(12) Patent Application Publication
(10) Pub. No.: US 2010/0317793 A1
(43) Pub. Date: Dec. 16, 2010

(54) RUBBER COMPOSITION WITH MOISTURE EXPOSED SURFACE CONTAINING COMBINATION OF SILICA AND SPECIALIZED TACKIFYING RESIN AND TIRE WITH COMPONENT THEREOF

(76) Inventor: Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/483,346

(22) Filed: Jun. 12, 2009

(51) Int. Cl. B60C 1/00; B29C 43/24; B29C 47/00; C08L 9/00

(52) U.S. Cl. 524/571; 264/175; 264/176.1

(57) ABSTRACT

An uncured silica-containing rubber composition having a moisture exposed surface wherein the rubber surface contains a combination of silica and a specialized tackifying resin. The moisture exposed silica degrades necessary building tack for the rubber composition. The specialized tackifying resin counteracts and significantly reduces said reduction of building tack caused by the silica/moisture interaction. Accordingly, a method of preparation of silica-containing uncured rubber is provided by processing the rubber under high shear, internal heat generation to cause the rubber composition to reach an elevated temperature followed by treating the surface of the heated rubber composition with moisture to cool the processed rubber composition where the surface of the rubber composition contains said silica together with a specialized tackifying resin. The invention further relates to building an assembly of uncured rubber components of which at east one of such components is a silica-containing moisture exposed rubber composition which contains said specialized tackifying resin. Such assembly is sulfur cured in a suitable mold at an elevated temperature to form a tire with said component, particularly where said component is an atmospherically exposed tire sidewall. Said specialized tackifying resin is a reaction product of t-butyl phenol and formaldehyde or vinyl modified product of t-butyl phenol and formaldehyde to the exclusion of sorbitan monostearate.

### FIELD OF THE INVENTION

An uncured silica-containing rubber composition having a moisture exposed surface wherein the rubber surface contains a combination of silica and a specialized tackifying resin. The moisture exposed silica degrades necessary building tack for the rubber composition. The specialized tackifying resin counteracts and significantly reduces said reduction of building tack caused by the silica/moisture interaction. Accordingly, a method of preparation of silica-containing uncured rubber is provided by shaping the rubber by processing under high shear, internal heat generation during extrusion or calendering to cause the rubber composition to reach an elevated temperature followed by treating the surface of the heated rubber composition with moisture to cool the processed rubber composition where the surface of the rubber composition contains said silica together with a specialized tackifying resin. The invention further relates to building an assembly of uncured rubber components of which at east one of such components is a silica-containing moisture exposed rubber composition which contains said specialized tackifying resin. Such assembly is sulfur cured in a suitable mold at an elevated temperature to form a tire with said component, particularly where said component is an atmospherically exposed tire sidewall. Said specialized tackifying resin is a reaction product of t-butyl phenol and formaldehyde or vinyl modified product of t-butyl phenol and formaldehyde to the exclusion of sorbitan monostearate.

### BACKGROUND OF THE INVENTION

Tire sidewalls are typically composed of carbon black reinforced rubber compositions. Often, the uncured rubber composition immediately following its mixing and processing is run through a water bath or on a conveyor while being sprayed with water to cool the rubber and retard any premature curing of the rubber while it is hot.

Often a tackifying resin comprised of a reaction product of t-octyl phenol and formaldehyde is used to promote building tack for the uncured rubber composition.

However, addition of precipitated silica reinforcement tends to “wet” the uncured rubber composition upon being exposed to the aforesaid cooling water after its high shear processing to shape the rubber composition by extrusion or calendering, particularly by extrusion, with an attendant internal heat generation and accompanying increase in temperature, its uncured rubber surface typically has insufficient suitable building tack even with inclusion of the tackifying resin product of t-octyl phenol and formaldehyde.

Accordingly a challenge is presented for enhancing the building tack of the surface of the precipitated silica-containing uncured rubber composition, particularly following its exposure to moisture such as, for example, by exposure to high humidity atmosphere or by direct exposure to water.

Moreover, the precipitated silica itself is hydrophilic in nature and therefore attracts water to typically result in a reduction in surface building tack of the uncured sidewall rubber component, particularly in a humid atmosphere or by direct application of cooling water onto an uncured sidewall rubber component in a tire manufacturing process. Such humid atmosphere, or application of cooling water, is usually applied to the uncured rubber component immediately after it is formed by, for example, a rubber extrusion process with its attendant internal heat generation.

It is an aspect of this invention to use precipitated silica reinforcement in a tire sidewall component in combination with a specialized tackifying agent to substantially maintain surface building tack of the uncured tire sidewall rubber component after its exposure to moisture.

It is to be appreciated that this invention is intended to go beyond a simple reduction or substantial elimination of a surface effect of the inclusion of precipitated silica in the uncured rubber composition insofar as building tack is concerned.

Indeed, an important aspect of this invention is an inclusion of the specialized tackifying resin to substantially retain building tack for the uncured surface of the sidewall rubber composition, particularly in the presence of moisture.

While it has previously been proposed to provide an enhancement of surface building tack of moisture exposed uncured rubber composition which contains a combination of sorbitan monostearate and vinyl monomer modified alkylphenol/formaldehyde resin, as seen in U.S. patent application Ser. No. 2009/0043039, it is desired herein to evaluate a possibility and to thereby provide enhanced moisture exposed surface building tack of a rubber composition which is required to contain silica without the presence of sorbitan monostearate.

In the description of this invention, the term “phr” where used relates to parts by weight of an ingredient per 100 parts by weight of rubber, unless otherwise indicated.

The terms “rubber” and “elastomer” are used interchangeably unless otherwise indicated. The terms “vulcanized” and “cured” are used interchangeably unless otherwise indicated. The terms “compound” and “rubber composition” may be used interchangeably unless indicated.

The term “building tack”, or “surface building tack” of the surface of an uncured rubber composition relates to surface tack present on the surface of the uncured rubber tire component which promotes adhesion between uncured rubber components when they are combined in the building of an uncured rubber tire. In this manner, the assembled uncured tire rubber components remain together prior to the curing of the tire assembly of rubber components. Such building tack and its use is well known to those having skill in such art.

### DISCLOSURE AND PRACTICE OF THE INVENTION

In accordance with this invention, a moisture exposed uncured rubber composition is provided which comprises, based on 100 parts by weight rubber (phr);

(A) at least one (100 phr) diene-based elastomer,

(B) from about 20 to about 120, alternately about 45 to about 90, phr of particulate rubber reinforcement comprised of a combination of rubber reinforcing carbon black and amorphous silica (e.g. precipitated silica) comprised of:
(1) about 10 to about 80, alternately from about 30 to about 60, phr of rubber reinforcing carbon black, and
(2) about 10 to about 50, alternately from about 15 to about 30, phr of amorphous silica (e.g. precipitated silica);
wherein said rubber composition contains a dispersion of greater than 3 phr, alternately between 3 and about 10 phr, alternately about 4 to about 8 phr, of a specialized tackifying resin comprised of:
   (a) a vinyl monomer modified reaction product of t-butyl phenol and formaldehyde in the absence of sorbitan monostearate, or
   (b) a reaction product of t-butyl phenol and formaldehyde (other than said vinyl monomer modified reaction product of t-butyl phenol and formaldehyde), and preferably also in the absence of sorbitan monostearate;
wherein at least one surface of said rubber composition contains a combination of said precipitated silica and said specialized tackifying resin.

Preferably said moisture exposed uncured rubber surface contains from 4 to about 8 phr of said tackifying resin and has a tack of at least 5 Newtons.

A method of shaping a silica-containing uncured rubber composition which comprises:

(A) extruding or calendering, preferably by extruding, said uncured rubber composition under high shear, internal heat generating conditions to thereby cause the temperature of the rubber composition to increase to an elevated temperature;

(B) treating said extruded or calendered uncured rubber composition at said elevated temperature with moisture to thereby cool the rubber composition;

wherein the rubber composition contains a combination of rubber reinforcing carbon black and synthetic amorphous silica (e.g. precipitated silica) comprised of:
(1) about 10 to about 80, alternately from about 30 to about 60, phr of rubber reinforcing carbon black, and
(2) about 10 to about 50, alternately from about 15 to about 30, phr of amorphous silica (e.g. precipitated silica);

and a dispersion of greater than 3 phr, alternately between 3 and about 10 phr, alternately about 4 to about 8 phr, of specialized tackifying resin;

wherein said tackifying resin is a product of t-butyl phenol and formaldehyde or a vinyl modified product of t-butyl phenol and formaldehyde in the absence of sorbitan monosterarate.

A method of preparing a silica-containing uncured rubber composition which comprises:

(A) processing said uncured rubber composition under high shear, internal heat generating conditions (such as, for example, by extrusion and/or by mixing) to thereby cause the temperature of the rubber composition to increase to an elevated temperature;

(B) treating the heated rubber composition with moisture (such as, for example, by direct application of water or by atmospheric high humidity) to thereby cool the rubber composition;

wherein the surface of the rubber composition contains a combination of said silica and a specialized tackifying resin;

wherein said tackifying resin is a product of t-butyl phenol and formaldehyde or a vinyl modified product of t-butyl phenol and formaldehyde in the absence of sorbitan monosterarate.

The specialized tackifying resin for this application is a resin derived from vinyl monomer modified t-butyl phenol and formaldehyde or a reaction product of t-butyl phenol and formaldehyde itself. This is distinguished from resins derived from t-butyl phenol and acetylene and distinguished from resins derived from t-octyl phenol and formaldehyde.

A significant aspect of this invention is the discovery of a beneficial use of a resin derived from vinyl monomer modified product of t-butyl phenol and formaldehyde or product of t-butyl phenol and formaldehyde, for providing surface building tack for the uncured moisture exposed silica reinforcement-containing rubber composition. Providing a suitable surface building tack is considered to be a particular challenge because of a surface tack defeating effect of moisture contact with the silica reinforcement contained in the rubber composition.

A further aspect in a practice of the invention was an observed significantly improved static/dynamic ozone resistance of a silica reinforcement-containing cured rubber surface which had been previously moisture exposed in its uncured state, and which contained the resin product of t-butyl phenol and formaldehyde or vinyl monomer modified product of t-butyl phenol and formaldehyde. Such observed effect was surprisingly unexpected and believed to have been a significant discovery.

In practice, said silica is typically used in combination with a silica coupler for said silica having a moiety reactive with hydroxyl groups (e.g. silanol groups) on said silica and another different moiety interactive with said diene-based elastomer(s).

In practice, said specialized tackifying resin may have, for example herein only, a softening point in a range of from about 90° C. to about 150° C.

In additional accordance with this invention the said uncured rubber composition is provided wherein at least one surface thereof is, or has been, exposed to moisture (moisture exposed), where said surface contains said precipitated silica and said specialized tackifying resin and, further, a sulfur cured rubber composition is provided of said moisture exposed uncured rubber composition.

Accordingly, in further accordance with this invention a sulfur cured rubber composition is provided by sulfur curing said uncured rubber composition which contains said moisture exposed surface containing said precipitated silica and specialized tackifying resin on its surface.

In further accordance with this invention, a tire component of an uncured rubber composition, such as for example a tire rubber sidewall component, is comprised of said uncured rubber composition having a surface containing a combination of said precipitated silica and said specialized tackifying resin.

In additional accordance with this invention, said uncured tire rubber component, for example a sidewall rubber component, is provided wherein at least one surface thereof which contains said precipitated silica and specialized tackifying resin is exposed to moisture and is therefore a moisture-exposed surface (surface having been exposed to moisture).

In additional accordance with this invention, a sulfur cured tire rubber component, for example a tire sidewall rubber component is provided by sulfur curing said uncured rubber component having said moisture exposed surface which contains said precipitated silica and said specialized tackifying resin on its surface.

In particular and in further accordance with this invention, said uncured tire rubber component, such as for example a tire rubber sidewall component surface is (has been) exposed to moisture (such as by direct application of water or by atmospheric high humidity conditions) during the formative processing thereof in its uncured state, (e.g. by high shear internal heat generating processing such as, for example by an extrusion process to thereby provide a shaped uncured rubber sidewall component at an elevated temperature which needs to be immediately cooled) and its moisture exposed surface is dried.

After drying the moisture-exposed surface of the uncured rubber composition, it is considered herein that the precipitated silica contains a water of absorption which tends to degrade surface building tack of the uncured rubber surface.

In additional accordance with this invention, an assembly of uncured rubber tire components is provided which contains said uncured rubber component, for example said tire sidewall rubber component, wherein said moisture-exposed uncured rubber component (e.g. sidewall rubber component, particularly a visible atmospherically exposed tire sidewall) has a surface with suitable building tack for building said uncured rubber component, for example the tire sidewall rubber component, into an assembly of uncured rubber tire components.

Further, such assembly is provided as a sulfur cured assembly.

In further accordance with this invention, a cured rubber tire is provided by curing the said assembly which contains said component, for example said sidewall component, in a suitable mold to form a cured rubber tire.

In additional accordance with this invention, such cured rubber tire (e.g. pneumatic rubber tire) is provided with said tire component, for example said tire sidewall component, having a visually observable, atmospherically exposed, outer surface comprised of said rubber composition which contains said precipitated silica and specialized resin on its visible outer surface.

This is considered herein to be significant in a sense of being able to promote, or provide, surface building tack for the uncured rubber component during the building of the rubber component into an assembly of tire rubber components prior to the curing step for the tire assembly.

In practice, the said vinyl monomer modifier for said reaction product of t-butyl phenol and formaldehyde may be comprised of, for example, at least one of styrene, alpha-methylstyrene, chlorostyrene, N,N-dimethylaminostyrene, aminostyrene, hydroxystrene, t-butylstyrene, carboxystyrene, divinylbenzene, vinylnaphthalene, vinyl pyridine, and mixtures thereof.

In one aspect, the vinyl monomer modification of the resin product of t-butyl phenol/formaldehyde may be accomplished by, for example, by acid catalysis, where appropriate.

For the purposes of this description, the “rubber composition” and “compounded” rubber compositions refer to the respective rubber compositions which have been compounded with appropriate compounding ingredients such as, for example, carbon black, oil, stearic acid, zinc oxide, wax, antidegradants, resin(s), sulfur and accelerator(s) as well as the aforesaid precipitated silica and specialized tackifying resin.

For the practice of this invention, a combination of cis 1,4-polyisoprene rubber (which can be selected from at least one of natural and synthetic rubber) and cis 1,4-polybutadiene rubber is used, usually preferably to the exclusion of other elastomers insofar as tire sidewall applications are concerned.

Various amounts of processing aids, if used, may, for example, comprise 1 to 50 phr. Such processing aids may include, for example, aromatic, napthenic, and/or paraffinic processing oils. Typical amounts of antioxidants may comprise, for example, about 1 to about 5 phr. Representative antioxidants may be, for example, diphenyl-p-phenylenediamine and others, such as, for example, those disclosed in the Vanderbilt Rubber Handbook (1978), Pages 344 through 346. Typical amounts of antiozonants comprise about 1 to about 5 phr. Typical amounts of fatty acids, if used, which can include stearic acid comprise about 0.5 to about 3 phr. Typical amounts of zinc oxide comprise about 2 to about 6 phr. Typical amounts of waxes, if used, may comprise, for example, about 1 to about 5 phr. Often microcrystalline waxes are used. Typical amounts of peptizers, if used, may comprise, for example, about 0.1 to about 1 phr. Typical peptizers may be, for example, pentachlorothiophenol and dibenzamidodiphenyl disulfide. The presence and relative amounts of the above additives are considered to be not an aspect of the present invention. Usually, for this invention, an inclusion in the rubber composition of a sorbitan monostearate is not used.

The vulcanization is conducted in the presence of a sulfur vulcanizing agent. Examples of suitable sulfur vulcanizing agents include elemental sulfur (free sulfur) or sulfur donating vulcanizing agents, for example, an amine disulfide, polymeric polysulfide or sulfur olefin adducts. Preferably, the sulfur vulcanizing agent is elemental sulfur. As known to those skilled in the art, sulfur vulcanizing agents may be used, for example, in an amount ranging from about 0.5 to about 4 phr, with a range of from about 0.5 to about 2.25 sometimes being preferred.

Accelerators are used to control the time and/or temperature required for vulcanization and to improve the properties of the vulcanizate. In one embodiment, a single accelerator system may be used, i.e., primary accelerator. Conventionally, a primary accelerator is used in amounts ranging from about 0.5 to about 2.0 phr. In another embodiment, combinations of two or more accelerators in which the primary accelerator is generally used in the larger amounts, 0.5 to 2 phr, and a secondary accelerator which is generally used in amounts of 0.05 to 0.50 phr in order to activate and to improve the properties of the vulcanizate. Combinations of these accelerators have been known to produce a synergistic effect on the final properties and are somewhat better than those produced by use of either accelerator alone. In addition, delayed action accelerators may be used which are not affected by normal processing temperatures but produce satisfactory cures at ordinary vulcanization temperatures. Various types of accelerators are, for example, various amines, disulfides, guanidines, thioureas, thiazoles, thiurams, sulfenamides, dithiocarbamates and xanthates. It is usually preferred that the primary accelerator is a sulfenamide. If a second accelerator is used, the secondary accelerator may preferably be a guanidine, dithiocarbamate or thiuram compound. The presence and relative amounts of sulfur vulcanizing agent and accelerator(s) are not considered to be an aspect of this invention.

Sometimes a combination of antioxidants, antiozonants may be collectively referred to as antidegradants.

The tire can be built, shaped, molded and cured by various methods which will be readily apparent to those having skill in such art.

The invention may be better understood by reference to the following Examples in which the parts and percentages are by weight unless otherwise indicated.

### EXAMPLE I

### Rubber Containing Carbon Black Reinforcement without Silica

Comparative Rubber Sample A was prepared to measure surface building tack of an uncured rubber composition which contained carbon black reinforcement, without containing silica reinforcement, together with a conventional tackifying resin in a form of a reaction product of p-octyl phenol and formaldehyde (Tackifying Resin AA).

The rubber composition contained natural rubber and cis 1,4-polybutadiene rubber.

Surface building tack of the uncured rubber composition was measured before and after moisture ageing of the uncured rubber composition.

Rubber Sample A contained 3 phr of Tackfying Resin AA.

The basic formulation for the rubber Samples for this Example is exemplified in the following Table 1 in which the parts are by weight unless otherwise indicated.

For the preparation of the Rubber Samples, in the first, or non-productive internal mixing stage, the ingredients were mixed for about 4 minutes to a drop temperature of about 150° C. In the second or productive mixing stage, sulfur and accelerator(s) were added and mixed for about 2 minutes to a drop temperature of about 110° C.

TABLE 1
Non-productive Mixing (NP) (4 min. to about 150° C.)

| | |
|---|---|
| Natural rubber | 40 |
| Cis 1,4-polybutadiene rubber¹ | 60 |
| Carbon black² | 51 |
| Antidegradants³ | 4.5 |
| Rubber processing oil | 14 |
| Wax⁴ | 1 |
| Tackifier Resin AA⁵ | 3 |

Productive Mixing Step (PR) (to about 110° C.)

| | |
|---|---|
| Zinc oxide | 3 |
| Sulfur and accelerators⁶ | 2.5 |

¹Cis 1,4-polybutadiene rubber as BUD ® 1207 from The Goodyear Tire & Rubber Company
²N550 rubber reinforcing carbon black, an ASTM designation.
³Blend of Santoflex ™ 6PPD from Flexsys and Wingstay 100 ® from The Goodyear Tire & Rubber Company
⁴Blend of microcrystalline and paraffinic waxes
⁵Tackifier Resin AA, a non-reactive product of t-octyl phenol and formaldehyde resin (para-tertiary octyl phenol), as SP1068 from SI Group, a generally used, common, rubber tackifying resin
⁶Sulfenamide and guanidine based sulfur cure accelerators

The results of original, air aged and moisture aged surface tack for the uncured rubber Samples are shown in Table 2.

TABLE 2

| | Sample A |
|---|---|
| Ingredient (phr) | |
| Tackifying Resin AA (t-octyl phenol/formaldehyde) | 3 |
| Carbon black reinforcement | 51 |
| Silica reinforcement | 0 |
| Tack Strength, Newtons (N), | |
| of uncured rubber Samples | |
| Original tack, without moisture exposure | 11 |
| Air aged tack (5 days in air at 23° C.) | 14.4 |
| Moisture aged tack, 40° C., | 8.2 |
| 90% relative humidity exposure (one day) | |

The Tack Strength is determined by a positive pressure tack test for interfacial tack between two uncured rubber samples by pulling apart two uncured rubber samples at ambient room temperature (e.g. 23° C.) which had been pressed together with a pressure of 0.2 MPa (30 psi) for 30 seconds following which the pressure is released. The force to pull the samples apart is measured in terms of Newtons (N) force.

In Table 2 it can be seen that the air aged surface tack of the carbon black reinforcement-containing uncured rubber composition increased to 14.4 Newtons from its original surface tack of 11 Newtons when using the conventional tackifying resin derived from t-octylphenol and formaldehyde.

It can further be seen that its moisture aged surface tack of the carbon black reinforcement-containing uncured rubber composition decreased to 8.2 Newtons which is considered herein to be an acceptable surface building tack for the carbon black reinforcement-containing uncured rubber composition when using the conventional t-octylphenol/formaldehyde tackifying resin.

### EXAMPLE II

### Rubber Containing Both Carbon Black and Silica Reinforcement

Experimental Rubber Samples B through F were prepared to evaluate an effect of building tack for the uncured rubber compositions when providing an inclusion of precipitated silica reinforcing filler, together with carbon black, in the rubber composition using various tackifying resins before and after air ageing and high humidity “moisture” ageing. The rubber composition did not contain sorbitan monostearate.

Rubber Sample B contained Tackifier AA as a resin product of t-octyl phenol and formaldehyde.

Rubber Sample C contained Tackifier BB, a resin product of t-butyl phenol and acetylene.

Rubber Sample D contained Tackifier CC as a hydrocarbon tackifying resin.

Rubber Sample E contained Tackifier DD as a vinyl monomer modified resin product of t-butyl phenol and formaldehyde.

Rubber Sample F contained Tackifier EE as an amine modified resin product of t-octyl phenol and formaldehyde.

It is important to appreciate that:

(A) Tackifier resin DD differs significantly from Tackifier resin AA in the sense that while both tackifiers are derived from formaldehyde, only Tackifier DD is derived from the combination of t-butyl phenol and formaldehyde, namely a vinyl monomer modified product of t-butyl phenol and formaldehyde, and that

(B) Tackifier resin DD differs significantly from Tackifier resin BB in the sense that while both tackifiers are derived from t-butyl phenol, only Tackifier DD is derived from formaldehyde, namely a vinyl monomer modified product of t-butyl phenol and formaldehyde.

Tackifier resin EE differs further from Tackifier resin DD in a sense that it is an amine modified product derived from t-octyl phenol and formaldehyde.

Tackifier CC differs further from Tackifier resin DD in a sense that it is a hydrocarbon derived resin.

The basic formulation for this Example is shown in the following Table 3, using materials indicated in Table 1 in which the parts are by weight unless otherwise indicated. The Rubber Samples were prepared in the manner of Example I.

TABLE 3
Non-productive Mixing (NP) (4 min. to about 150° C.)

| | |
|---|---|
| Natural rubber | 50 |
| Cis 1,4-polybutadiene rubber | 50 |
| Carbon black | 30 |
| Tackifier Resin AA, BB, CC, DD or EE⁸ | 3 |
| Rubber processing oil | 4 |
| Silica coupling agent⁹ | 5 |
| Precipitated silica¹⁰ | 30 |
| Antidegradant | 5.3 |
| Zinc oxide | 1.5 |
| Wax | 1.5 |

Productive Mixing Step (PR) (to about 110° C.)

| | |
|---|---|
| Sulfur and accelerators | 2.5 |

⁸Tackifying resin AA, derived from t-octyl phenol and formaldehyde as SP1068 ™ from the SI Group; tackifying resin BB, derived from t-butyl phenol and acetylene as Koresin ™ from Ludwigshafen; tackifying resin CC, derived from petroleum hydrocarbon as Escorez 1102 ™ from ExxonMobil; tackifying resin DD, vinyl monomer modified resin derived from t-butyl phenol and formaldehyde as Elaztobond T2000 ™ from the SI Group; and tackifying resin EE, amine modified resin derived from t-octyl phenol and formaldehyde as Elaztobond T8000 ™ from the SI Group

The cure behavior and various cured physical properties for the compositions are shown in Table 4 and are provided in the manner of Example I.

TABLE 4

| | Sample | | | | |
|---|---|---|---|---|---|
| | B | C | D | E | F |
| Silica | 30 | 30 | 30 | 30 | 30 |
| Carbon black | 30 | 30 | 30 | 30 | 30 |
| Tackifying Resin AA (t-octyl phenol | 3 | 0 | 0 | 0 | 0 |
| and formaldehyde) | | | | | |
| Tackifying Resin BB (t-butyl phenol | 0 | 3 | 0 | 0 | 0 |
| and acetylene) | | | | | |
| Tackifying Resin CC (petroleum | 0 | 0 | 3 | 0 | 0 |
| resin) | | | | | |
| Tackifying Resin DD (vinyl | 0 | 0 | 0 | 3 | 0 |
| monomer modified resin derived | | | | | |
| from t-butyl phenol and | | | | | |
| formaldehyde) | | | | | |
| Tackifying Resin EE (amine | 0 | 0 | 0 | 0 | 3 |
| modified resin from t-octyl phenol | | | | | |
| and formaldehyde) | | | | | |
| Tack Strength, N, of uncured | | | | | |
| rubber Samples | | | | | |
| Original tack, without moisture | 3.5 | 3.2 | 2.4 | 11 | 3.2 |
| exposure | | | | | |
| Air aged tack (5 days in air at 23° C.) | 4.9 | 3.5 | 2.5 | 6.7 | 3.9 |
| Moisture aged tack (1 day, 40° C., | 1.8 | 1.8 | 1.4 | 3.1 | 1.4 |
| 90% relative humidity exposure) | | | | | |

It can be seen from Table 4 that the only tackifer resin which provided an adequate improvement in original unaged surface tack of at least 5 Newtons for the uncured rubber combined with air aged surface tack of at least 5 Newtons for the uncured rubber was tackifying resin DD (for rubber Sample E), namely the vinyl monomer modified product of t-butyl phenol and formaldehyde.

However it is seen from Table 4 that the moisture aged surface tack for the uncured rubber Sample E (using the Tackifier resin DD) was below a desirable 5 Newtons even though it yielded a moisture aged surface tack superior to the other comparative tackifying resins AA, BB, CC and EE.

Accordingly, it is concluded herein that the inclusion of the Tackifer resin DD, the vinyl monomer modified t-butyl phenol/formaldehyde resin, provided the best of all of the original surface tack, air aged surface tack and moisture (humidity) aged surface tack for the uncured rubber at the 3 phr level, as observed for rubber Sample E in Table 4, as compared to use of resins AA, BB, CC and EE.

However, even with this beneficial comparative rubber surface tackifying result, the observed moisture (humidity) aged tack provided by Tackifier resin DD, as observed by rubber Sample E, was less than a more desirable 5 Newtons.

It is further concluded that the tackifying resins AA, BB, CC and EE, which are significantly different from Tackifying resin DD, provided less than a desirable 5 Newtons of all of the original surface tack, air aged surface tack and moisture aged surface tack for the uncured rubber Samples B, C, D and F, respectively, at the 3 phr level.

### EXAMPLE III

### Rubber Containing Both Carbon Black and Silica Reinforcement

Experimental Rubber Samples G through K were prepared to evaluate an effect of surface building tack for the uncured rubber compositions when providing an inclusion of precipitated silica reinforcing filler in the rubber composition, without an inclusion of sorbitan monostearate.

For this Example, the surface building tack was evaluated for original and moisture aged surface tack

For this example, an increased level of 5 phr of the tackifying resins was used.

The basic formulation is exemplified in the following Table 5, using materials indicated in Table 3 in which the parts are by weight unless otherwise indicated.

The Rubber Samples were prepared in the manner of Example I.

TABLE 5
First Non-productive Mixing Step (NP1) (4 min. to about 150° C.)

| | |
|---|---|
| Natural rubber | 50 |
| Cis 1,4-polybutadiene rubber | 50 |
| Carbon black | 30 |
| Tackifier Resin AA, DD, FF, GG or EE⁹ | 5 |
| Rubber processing oil | 4 |
| Silica coupling agent | 5 |
| Precipitated silica | 30 |
| Antidegradant | 5.3 |
| Zinc oxide | 1.5 |
| Wax | 1.5 |

Productive Mixing Step (PR) (to about 110° C.)

| | |
|---|---|
| Sulfur and accelerators⁵ | 2.5 |

⁹Tackifying resin AA, derived from t-octyl phenol and formaldehyde as SP1068 ™ from the SI Group (as in Example I); tackifying resin DD, vinyl monomer modified resin derived from t-butyl phenol and formaldehyde as Elaztobond T2000 ™ from the SI Group (as in Example I); tackifying resin EE, amine modified resin derived from of t-octyl phenol and formaldehyde as Elaztobond T8000 ™ from the SI Group (as in Example I); tackifying resin FF, derived from t-butyl phenol and formaldehyde as T3100 ™ from the SI Group without a vinyl monomer modification; and tackifying resin GG, derived from t-octyl phenol and formaldehyde as T6000 ™ from the SI Group.

The cure behavior and various cured physical properties for the compositions are shown in Table 6 and are provided in the manner of Example I.

TABLE 6

| | Samples | | | | |
|---|---|---|---|---|---|
| | Control G | H | I | J | K |
| Silica | 30 | 30 | 30 | 30 | 30 |
| Carbon black | 30 | 30 | 30 | 30 | 30 |
| Tackifying Resin AA (t-octyl phenol and formaldehyde) | 5 | 0 | 0 | 0 | 0 |
| Tackifying Resin DD (vinyl monomer modified | 0 | 5 | 0 | 0 | 0 |
| resin of t-butyl phenol and formaldehyde) | | | | | |
| Tackifying Resin FF (product of t-butyl phenol | 0 | 0 | 5 | 0 | 0 |
| and formaldehyde) | | | | | |
| Tackifying Resin GG (t-octyl phenol and formaldehyde) | 0 | 0 | 0 | 5 | 0 |
| Tackifying Resin EE (amine modified resin of | 0 | 0 | 0 | 0 | 5 |
| t-octyl phenol and formaldehyde) | | | | | |
| Tack Strength, N, of uncured rubber Samples | | | | | |
| Original tack, without moisture exposure | 9 | 14.8 | 12.2 | 9.9 | 10.6 |
| Moisture aged tack (40° C., 90% relative humidity) | | | | | |
| 1 day | 2.7 | 9.1 | 5 | 3.7 | 5.2 |
| 5 days | 3.2 | 8.2 | 7.7 | 3.2 | 3.3 |
| Rheometer, 50° C. | | | | | |
| T90, minutes | 11 | 9.6 | 12.3 | 12.1 | 12.2 |
| Stress-strain | | | | | |
| Tensile strength, MPa | 16.2 | 15.3 | 16.5 | 16 | 15.9 |
| Elongation at break % | 657 | 656 | 678 | 663 | 642 |
| 300% ring modulus | 6.3 | 6.1 | 6.2 | 6.2 | 6.5 |
| Rebound, (%), 100° C. | 54 | 53 | 54 | 54 | 54 |
| Hardness, Shore A, 100° C. | 57 | 56 | 56 | 57 | 58 |
| Static ozone test observations of cured rubber | | | | | |
| Samples Ozone 50 pphm, 48 hours, 40° C., | | | | | |
| Variable Strain | | | | | |
| Crack Density (surface containing cracks) | 2 | 1 | 1 | 2 | 2 |
| Crack Severity (size of cracks) | 3 | 2 | 1 | 2 | 2 |
| Crack Density × Severity | 6 | 2 | 1 | 4 | 4 |
| Dynamic ozone test observations of cured rubber | | | | | |
| Samples Ozone 50 pphm, 48 hours, 40° C., | | | | | |
| 60% Strain | | | | | |
| Days until Sample broke during test | 14 | 18 | 16 | 14 | 14 |

The following is used as a key to report visual observations of cracks, if any, occurring on surface of representative Samples submitted to the ozone tests:

Crack Density (Average Portion of the Surface of the Sample which Contained Cracks)

0=none

1=less than ¼ of the surface

2=from ¼ to ½ of the surface

3=from ½ to ¾ of the surface

### Crack Severity (Average Size Of Cracks)

1=small (hairline cracks)

2=medium

3=large

4=severe (open cracks)

Crack Density times Crack Severity is considered herein as a measure of an overall ozone resistance of the rubber with a higher value being indicative of worse ozone resistance to rubber surface degradation.

It can be seen from Table 6 that the only tackifer resins which provided an acceptable combination of original unaged surface tack and moisture aged surface tack of at least 5 Newtons for the uncured silica-containing rubber were both of the tackifying resins DD and FF, namely the vinyl monomer modified resin derived from t-butyl phenol and formaldehyde and resin derived from t-butyl phenol and formaldehyde without the vinyl monomer modification which were contained in rubber Samples H and I, respectively.

Also, the significantly improved static dynamic ozone resistance of the moisture exposed, silica reinforcement-containing, rubber surface for the rubber Samples H and I which contained the tackifying resins DD and FF, respectively, was surprisingly unexpected and is considered herein as being a significant discovery.

From Table 6 it can be seen that both the vinyl monomer modified resin product of t-butyl phenol/formaldehyde (resin Tackifier DD of Sample H) and the resin product of t-butyl phenol/formaldehyde (resin Tackifier FF of Sample I) provided what is considered herein as satisfactory building tack for the moisture exposed uncured rubber surface.

Further, it can be seen from Table 6 that static and dynamic ozone resistance of the cured rubber surfaces were basically equivalent for both the tackifier resin based upon the vinyl monomer modified resin product of t-butyl phenol/formaldehyde and the tackifier resin product of t-butyl phenol/formaldehyde.

While certain representative embodiments and details have been shown for the purpose of illustrating the invention, it will be apparent to those skilled in this art that various changes and modifications may be made therein without departing from the spirit or scope of the invention.

What is claimed is:

1. A moisture exposed uncured rubber composition which comprises, based on 100 parts by weight rubber (phr);
(A) at least one (100 phr) diene-based elastomer,
(B) from about 20 to about 120 phr of particulate rubber reinforcement comprised of a combination of rubber reinforcing carbon black and precipitated silica comprised of:
(1) about 10 to about 80 phr of rubber reinforcing carbon black, and
(2) about 10 to about 50 phr of precipitated silica;
wherein said rubber composition contains a dispersion of greater than 3 phr of a specialized tackifying resin comprised of:
(a) a vinyl monomer modified reaction product of t-butyl phenol and formaldehyde in the absence of sorbitan monostearate, or
(b) a reaction product of t-butyl phenol and formaldehyde;
wherein at least one surface of said rubber composition contains a combination of said precipitated silica and said specialized tackifying resin;
wherein said rubber composition contains a silica coupler for said precipitated silica having a moiety reactive with hydroxyl groups contained on said precipitated silica and another different moiety interactive with said diene based elastomer(s).

2. The uncured rubber composition of claim 1 which contains from about 4 to about 8 phr of said specialized resin with at least one surface having a moisture aged tack of at least 5 Newtons.

3. A method of shaping a silica-containing uncured rubber composition which comprises:
(A) extruding or calendering said uncured rubber composition to thereby shape said uncured rubber composition and cause the temperature of the shaped rubber composition to increase to an elevated temperature;
(B) treating said extruded or calendered uncured shaped rubber composition at said elevated temperature with moisture to thereby cool the rubber composition;
wherein the rubber composition contains a combination of rubber reinforcing carbon black and precipitated silica comprised of:
(1) about 10 to about 80 phr of rubber reinforcing carbon black, and
(2) about 10 to about 50 phr of precipitated silica; and a dispersion of greater than 3 phr of a specialized tackifying resin;
wherein said tackifying resin is a product of t-butyl phenol and formaldehyde or a vinyl modified product of t-butyl phenol and formaldehyde in the absence of sorbitan monosterarate.

4. The rubber composition of claim 1 wherein said specialized resin is said product of t-butyl phenol and formaldehyde without vinyl monomer modification.

5. The rubber composition of claim 1 wherein said specialized resin is said vinyl monomer modified product of t-butyl phenol and formaldehyde.

6. The rubber composition of claim 5 wherein said vinyl monomer for said vinyl monomer modified product of t-butyl phenol and formaldehyde is comprised of at least one of styrene, alpha-methylstyrene, chlorostyrene, N,N-dimethylaminostyrene, aminostyrene, hydroxystrene, t-butylstyrene, carboxystyrene, divinylbenzene, vinylnaphthalene, vinyl pyridine, and mixtures thereof.

7. The rubber composition of claim 5 wherein said vinyl monomer for said vinyl monomer modified product of t-butyl phenol and formaldehyde is comprised of at least one of styrene and alpha-methylstyrene.

8. The rubber composition of claim 6 wherein the vinyl modification of said vinyl monomer modified product of t-butyl phenol and formaldehyde is by acid catalysis.

9. The rubber composition of claim 2 wherein said specialized resin is said product of t-butyl phenol and formaldehyde without vinyl monomer modification.

10. The rubber composition of claim 2 wherein said specialized resin is said vinyl monomer modified product of t-butyl phenol and formaldehyde.

11. The rubber composition of claim 10 wherein said vinyl monomer for said vinyl monomer modified product of t-butyl phenol and formaldehyde is comprised of at least one of styrene, alpha-methylstyrene, chlorostyrene, N,N-dimethylaminostyrene, aminostyrene, hydroxystrene, t-butylstyrene, carboxystyrene, divinylbenzene, vinylnaphthalene, vinyl pyridine, and mixtures thereof.

12. The method of claim 3 wherein said specialized resin is said product of t-butyl phenol and formaldehyde without vinyl monomer modification.

13. The method of claim 3 wherein said specialized resin is said vinyl monomer modified product of t-butyl phenol and formaldehyde.

14. A sulfur cured shaped rubber composition of claim 1.

15. A shaped tire component comprised of a sulfur cured rubber composition prepared by the method of claim 3 having a surface containing said precipitated silica and specialized tackifying resin.

16. The shaped tire component of claim 15 wherein said sulfur cured rubber composition is a tire sidewall.

17. A tire component comprised of an extrusion or calendered shaped uncured rubber composition of claim 1 wherein said surface of said shaped rubber composition has been exposed to moisture during a said shaping thereof in its uncured state, following which its moisture exposed surface is dried and wherein a portion of the moisture is retained by said precipitated silica.

18. An assembly of uncured rubber components which contains said shaped tire component prepared by the method of claim 17 wherein said shaped tire component is a tire sidewall.

19. A tire prepared by curing the assembly of claim 18 containing said shaped tire sidewall component in a suitable mold to form a tire.

20. A tire prepared by curing an assembly of uncured rubber components wherein at least one of said components is comprised of the uncured rubber composition of claim 1 having been shaped by extrusion or calendering wherein said surface of said shaped rubber composition has been exposed to moisture after said shaping thereof in its uncured state, following which its moisture exposed surface is dried and wherein a portion of the moisture is retained by said precipitated silica.
